(19) United States
(12) Patent Application Publication
(10) Pub. No.: US 2007/0150273 A1
(43) Pub. Date: Jun. 28, 2007

(54) INFORMATION RETRIEVAL APPARATUS AND METHOD

(76) Inventors: Hiroki Yamamoto, Kanagawa-ken (JP); Michio Aizawa, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/615,160

(22) Filed: Dec. 22, 2006

(30) Foreign Application Priority Data
Dec. 28, 2005 (JP) 2005-380168

(51) Int. Cl. G10L 15/00

(52) U.S. Cl. 704/231; 704/270

(57) ABSTRACT

An information retrieval apparatus which retrieves a program by using speech recognition is provided. A recognition dictionary storage unit stores a recognition dictionary in which a lexicon for the speech recognition is described. A program information storage unit stores program information data. A viewing history storage unit stores a viewing history containing information of the viewed frequency of a program which a user viewed in the past. When a program which satisfies a criterion concerning the viewed frequency is extracted from the program information data, a related word of the extracted program is registered in the recognition dictionary. A speech recognition unit performs speech recognition with respect to an input speech by using the recognition dictionary in which the related word is registered. A retrieval unit retrieves a program corresponding to the result of the speech recognition from the program information data.

### BACKGROUND OF THE INVENTION

1. Field of the Invention

The present invention relates to an information retrieval technique of retrieving information such as a program by using speech recognition.

2. Description of the Related Art

For example, Japanese Patent Application Laid-Open Nos. 2004-32349, 2005-27043, and 2004-295102 (patent references 1 to 3) disclose information retrieval apparatuses which perform program retrieval by using an electronic program guide (EPG).

The information retrieval apparatus disclosed in patent references 1 and 2 is configured to retrieve a program containing a synonym or related word with respect to an input keyword when performing program retrieval using an EPG.

The information retrieval apparatus disclosed in patent reference 3 is designed to determine words to be registered in a recognition dictionary and weights to be applied to words on the basis of the viewing history of a user and the usage history of speech recognition in the past, thereby allowing the user to easily recognize programs which the user frequently view or viewed in the past.

A word or a set of words which is registered in a recognition dictionary and can be recognized by speech recognition will be called a “lexicon”.

In addition, Japanese Patent Application Laid-Open Nos. 10-274996 and 3-147010 (patent references 4 and 5) disclose a speech recognition apparatus designed to obtain a desired result by registering synonyms and different pronunciations of a lexicon item even if the user vaguely memorizes that item.

When speech recognition is applied to the information retrieval apparatus disclosed in patent references 1 and 2, the user utters a keyword related to a program. When retrieving a program using speech recognition, the user himself/herself may utter a keyword for program retrieval in an abbreviated or synonymous form like “JTV” as “Japan TV” or “News at 9” as “News 9” broadcast from 9:00.

The speech recognition apparatus disclosed in patent references 4 and 5 registers in advance, in a recognition dictionary, bynames and synonyms of a lexicon item which are expected to be input. This allows the user to obtain desired speech recognition results without being especially conscious of words registered in the recognition dictionary. Likewise, the convenience for the user in program retrieval is improved by adding titles, stations, the abbreviated names or bynames of performers which are necessary for program retrieval, and keywords related to programs (bynames or abbreviated names and keyword related to programs will be generically referred to as “related words” hereinafter) to a recognition dictionary in advance on the basis of the program information distributed by an EPG.

If, however, the number of programs distributed by an EPG increases with an increase in the number of channels, the number of related words to be added to the recognition dictionary becomes enormous, resulting in a decrease in recognition rate.

Another challenge in the prior art is associated with a method of recording a viewing history.

Some users may view TV programs only in specific time owing to their living habits, and other users may preferably view programs broadcast by specific stations in specific time slots instead of specific programs. For example, many of users who work at companies in weekdays often watch TVs at home after work. Some users view the drama broadcast at the same time every week without fail. A program in such a time slot achieves a constant audience rating while the contents of the broadcast and the title change in a predetermined cycle. It can therefore be estimated that there are users who tends to view a program in this time slot.

The information retrieval apparatus disclosed in patent reference 1 records the viewing history of the user for each title. Using such a method of recording viewing histories, when the title changes, the apparatus must count a viewing history from 0 again even with respect to a program in the same time slot. In addition, an EPG sometimes distributes abbreviated titles. In such a case, the corresponding broadcast history becomes 0 even in the middle of the same program. The method of recording viewing histories disclosed in patent reference 1 is not suitable for a user who habitually views a program in a specific time slot without being especially conscious of the program, or a user who tends to view a program in the same time slot. Furthermore, this method is not suitable for a case wherein the title of a program distributed is abbreviated halfway.

### SUMMARY OF THE INVENTION

According to one aspect of the present invention, an information retrieval apparatus which retrieves a program by using speech recognition is provided. A recognition dictionary storage unit stores a recognition dictionary in which a lexicon for the speech recognition is described. A program information storage unit stores program information data. A viewing history storage unit stores a viewing history containing information of the viewed frequency of a program which a user viewed in the past. When a program which satisfies a criterion concerning the viewed frequency is extracted from the program information data, a related word of the extracted program is registered in the recognition dictionary. A speech recognition unit performs speech recognition with respect to an input speech by using the recognition dictionary in which the related word is registered. A retrieval unit retrieves a program corresponding to the result of the speech recognition from the program information data.

Further features of the present invention will become apparent from the following description of exemplary embodiments with reference to the attached drawings.

### BRIEF DESCRIPTION OF THE DRAWINGS

FIG. 1A is a block diagram showing the hardware arrangement of a program retrieval apparatus according to an embodiment;

FIG. 1B is a block diagram showing the functional arrangement of the program retrieval apparatus according to this embodiment;

FIG. 2 is a view showing an example of the data structure of program information data in the embodiment;

FIG. 3 is a view showing an example of the data structure of a viewing history in the embodiment;

FIG. 4 is a view showing an example of the data structure of a related word dictionary in the embodiment;

FIG. 5 is a view showing an example of the data structure of a keyword recognition dictionary in the embodiment;

FIG. 6 is a view showing an example of the data structure of a related word recognition dictionary in the embodiment;

FIG. 7 is a view showing an example of the data structure of a frequency-weights lookup table in the embodiment;

FIG. 8 is a flowchart showing recognition dictionary creation processing in the embodiment;

FIG. 9 is a flowchart showing program retrieval processing in the embodiment;

FIG. 10 is a view showing a modification of the data structure of a viewing history; and

FIG. 11 is a view showing another modification of the data structure of a viewing history.

### DESCRIPTION OF THE EMBODIMENTS

Preferred embodiments of the present invention will be described in detail in accordance with the accompanying drawings. The present invention is not limited by the disclosure of the embodiments and all combinations of the features described in the embodiments are not always indispensable to solving means of the present invention.

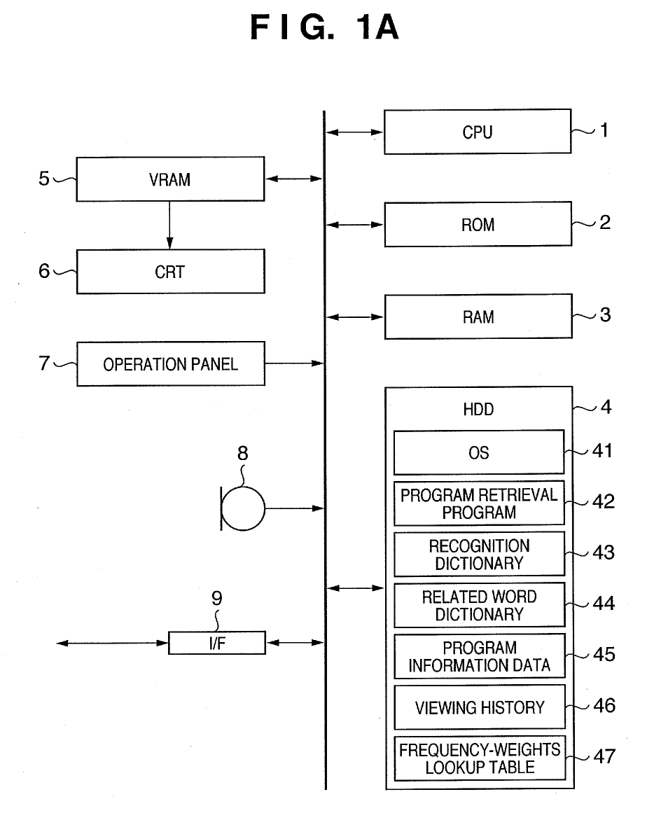

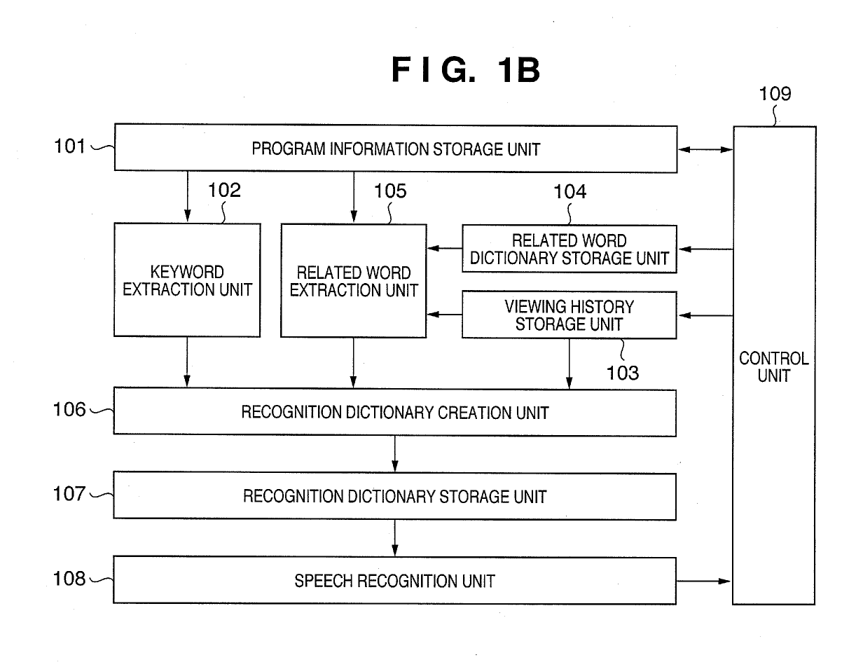

FIG. 1A is a block diagram showing an example of the hardware arrangement of a program retrieval apparatus as an example of an information processing apparatus according to this embodiment.

This program retrieval apparatus comprises the following components in addition to a CPU 1 which controls the overall apparatus, a ROM 2 storing a boot program and permanent data, and a RAM 3 which functions as a main memory and provides a work area for the CPU 1.

An HDD 4 is a hard disk unit. As shown in FIG. 1A, the HDD 4 stores an OS 41, a program retrieval program 42 (to be described later), a recognition dictionary 43, a related word dictionary 44, program information data 45 such as an EPG, a viewing history 46, and a frequency-weights lookup table 47. A VRAM 5 is a memory which bitmaps image data to be displayed. Bitmapping image data or the like in this memory makes it possible to display an image on a CRT 6. Reference numeral 7 denotes an operation panel for making various settings; 8, a microphone which inputs voice; and 9, an interface (I/F) for connection to a network such as the Internet.

Note that this program retrieval apparatus may be built in a television receiver, video recording apparatus, or the like.

FIG. 1B is a block diagram showing the functional arrangement of the program retrieval apparatus described above.

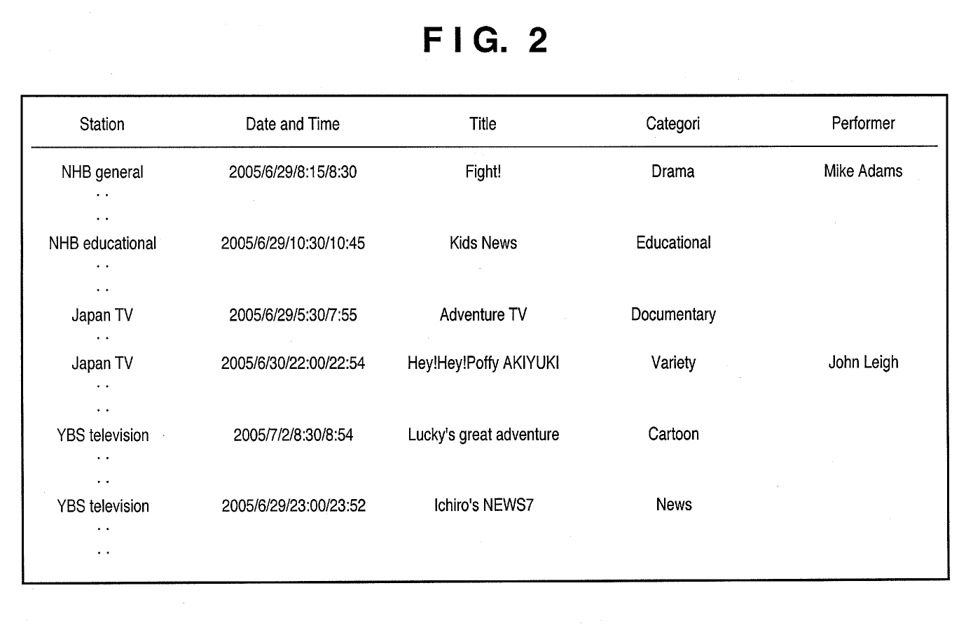

A program information storage unit 101 stores the program information data 45 such as an EPG received by a control unit 109. This storage unit is implemented by the HDD 4 shown in FIG. 1A. FIG. 2 shows an example of the data structure of the program information data 45. As shown in FIG. 2, the arrangement of the program information data 45 includes attribute data of “station”, “date and time”, “title”, “category”, and “performer”.

A keyword extraction unit 102 extracts a keyword necessary for retrieving a program by using speech recognition from the program information data 45 stored in the program information storage unit 101. This embodiment extracts two types of keywords, namely “station” and “title”. In addition, the embodiment may allow the user to select the types of keywords to be extracted through the control unit 109.

A viewing history storage unit 103 stores the information of a program which the user viewed in the past as the viewing history 46. This unit is implemented by the HDD 4 as shown in FIG. 1A. In this specification, if, for example, this program retrieval apparatus is implemented as part of a television receiver, a given program is assumed to be “viewed” when it is displayed on the TV screen. In contrast, if this program retrieval apparatus is implemented as part of a video recording apparatus, a given program may be regarded as “viewed” when it is recorded or the recorded video is played back.

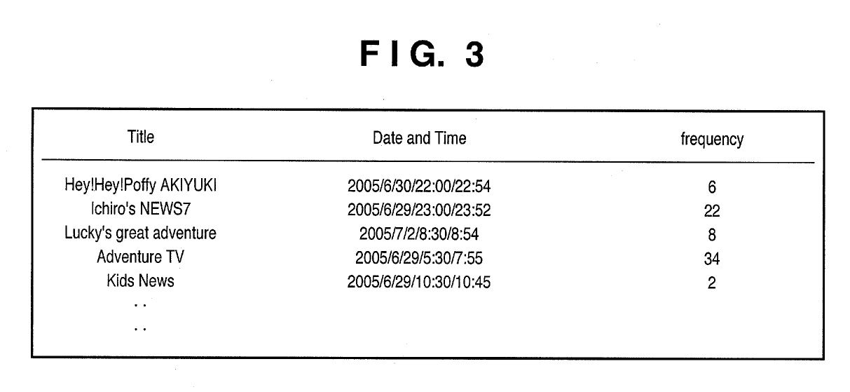

FIG. 3 shows an example of the data structure of the viewing history 46. As shown in FIG. 3, the viewing history 46 has an arrangement including the data of “title” of each program, “viewing date and time” indicating the date and time at which each program was lastly viewed, and “frequency” of each program. When the user views a given program, “viewing date and time” of the program is updated to the time when the user started to view the program, and “frequency” increases by one. When updating “viewing date and time, this apparatus updates only the viewing date and time without changing the frequency if the viewing date and time of the program before updating are after the start time of broadcasting of the program. This makes it possible to prevent double counting of the viewed frequency of, for example, a soccer program when the user temporarily views a news program while viewing the soccer program, and then views the succor program again. In addition, for example, the following restriction is preferably imposed. When recording a viewing history, the apparatus regards that a given program is viewed, when, for example, the user views the program for a predetermined period of time or more, or views a predetermined ratio of the total broadcasting time of the program. Furthermore, the apparatus may delete, from the viewing history 46, a program when a predetermined period of time has elapsed since its viewing date and time.

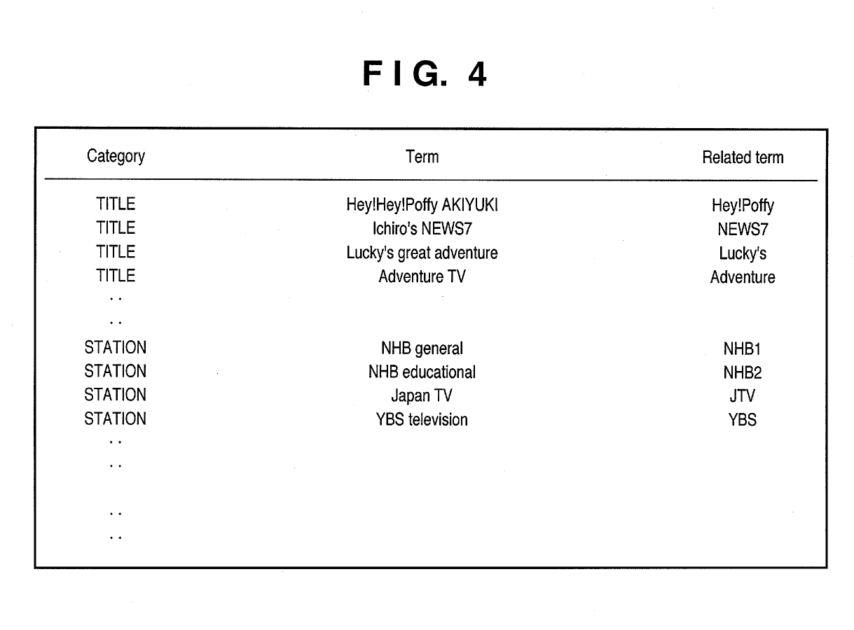

A related word dictionary storage unit 104 stores, for each word, related words such as a synonym, abbreviated name, and byname of the word, in the related word dictionary 44. This unit is implemented by the HDD 4, as shown in FIG. 1A. FIG. 4 shows an example of the data structure of the related word dictionary 44. As shown in FIG. 4, the related word dictionary 44 stores an abbreviated name or another name of the name of a title or station. The related word dictionary 44 may be the one created in advance, or an externally provided related word dictionary may be received by the control unit 109 so as to be updated. Alternatively, the user may freely perform editing operation, e.g., adding or deleting related words through the control unit 109. Furthermore, in addition to such data, the related word dictionary 44 may contain synonym data, thesaurus data, and the like which are generally used.

A related word extraction unit 105 acquires a program exhibiting a viewing history satisfying a predetermined criterion from the program information data 45, and extracts a related word of the acquired program by referring to the related word dictionary 44. Assume that with regard to a viewing history, a criterion is a frequency of 10 or more. Consider, for example, the viewing history 46 shown in FIG. 3. The programs which satisfy the criterion, i.e., exhibit frequencies of 10 or more, are “Ichiro's NEW 7” and “Adventure TV”. The related word extraction unit 105 then extracts related words of keywords of these two programs, e.g., “station”, “date and time”, “title”, “performer”, and “category”, by referring to the related word dictionary 44. When, for example, extracting related words of “title” by referring to the related word dictionary 44 shown in FIG. 4, the related word extraction unit 105 extracts “Adventure” with respect to “Adventure TV” and “NEWS 7” with respect to “Ichiro's NEWS 7”. In this case, although the related word extraction unit extracts only related words of “title”, it is obvious that the unit can extract related words of a plurality of types of keywords. In addition, the apparatus may be configured to allow the user to extract the type of keyword for extracting a related word through the control unit 109.

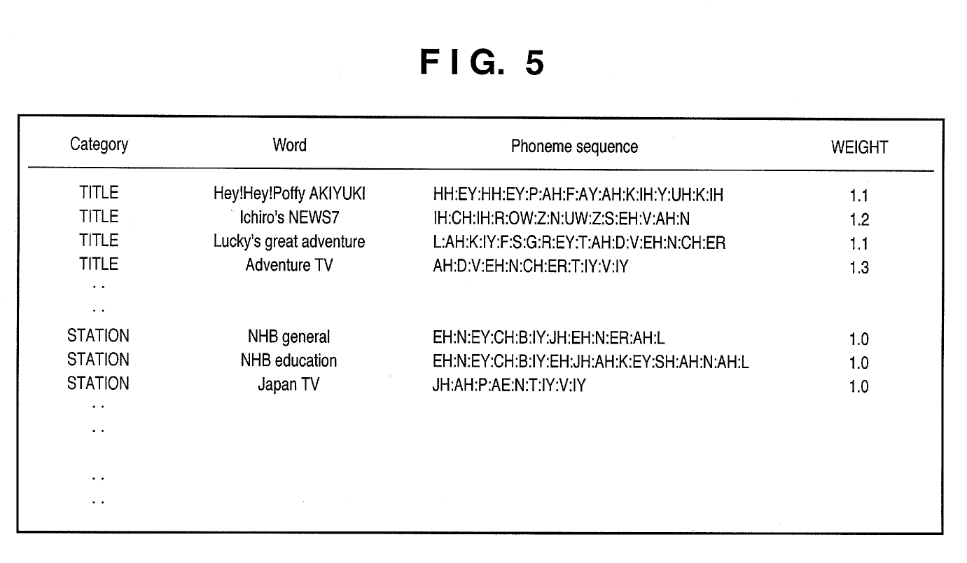

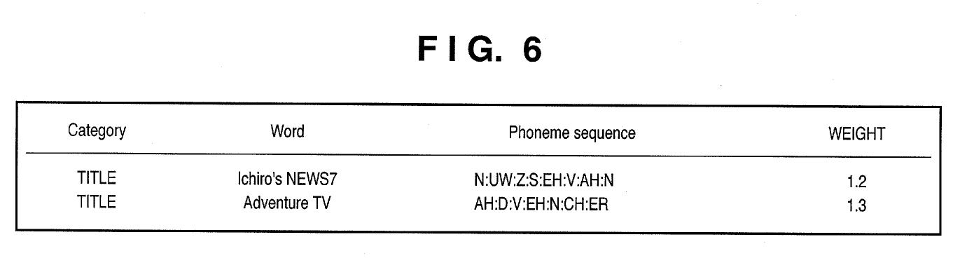

A recognition dictionary creation unit 106 creates recognition dictionaries 43 like those shown in FIGS. 5 and 6 by information such as a phonetic description necessary for speech recognition and the weight determined on the basis of a viewing history to each extracted keyword and each extracted related word. In this context, phonetic description indicates a pronunciation of a word by predefined phonetic symbols such as those defined by the IPA (International Phonetic Alphabet). FIG. 5 shows an example of the recognition dictionary created from the keywords extracted by the keyword extraction unit 102. FIG. 6 shows an example of the recognition dictionary created from the words extracted by the related word extraction unit 105. In this case, as the words of related words recorded on the related word recognition dictionary, the words written in program information are recorded. However, the words of the related words may be used without any change. In addition, although different recognition dictionaries are created by respectively using keywords and related words, one recognition dictionary may be created by using keywords and related words together. Alternatively, an individual recognition dictionary may be created for each word type.

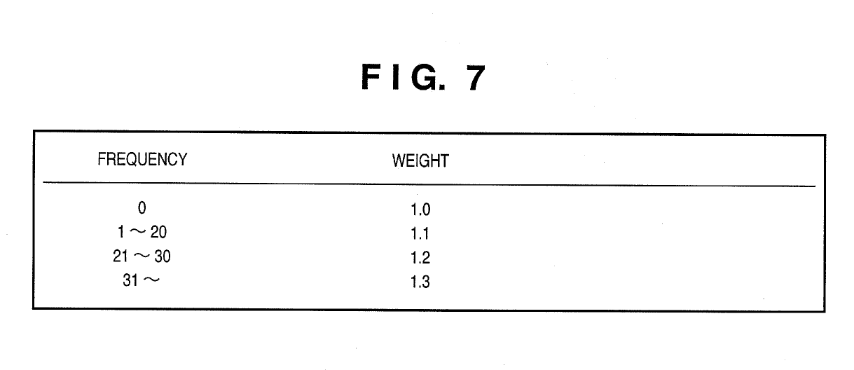

When a speech recognition unit 108 is to obtain a recognition result, the weights of words are determined to facilitate recognition of programs with high frequencies in a viewing history. For example, such a weight may be determined as a multiplication coefficient to multiply the recognition score of each word calculated by the speech recognition unit 108, or may be determined as an addition coefficient to be added to the recognition score of each word. This embodiment uses multiplication coefficients as weights, and determines weights by referring to the viewing history 46 and the frequency-weights lookup table 47 describing weight values for the respective frequencies in a viewing history like that shown in FIG. 7. For example, with regard to “Hey! Hey! Poffy AKIYUKI” with a frequency of 6 in the viewing history 46 in FIG. 3, a weight of 1.1 is provided for the recognition dictionary 43 shown in FIG. 5 by referring to the frequency-weights lookup table 47 in FIG. 7. Likewise, with regard to “Adventure TV” with a frequency of 34 in the viewing history 46, a weight of 1.3 is provided for the recognition dictionary 43 shown in FIG. 5 by referring to the frequency-weights lookup table in FIG. 7. In addition, a weight of 1.3 is provided for “Adventure” which is a related word of “Adventure TV”. In the above description, a weight is provided for the word of a title. However, the present invention is not limited to this, and it suffices to provide weights for “station” and “category”.

A recognition dictionary storage unit 107 stores the recognition dictionary 43 created by the recognition dictionary creation unit 106. The unit 107 is implemented by the HDD 4 as shown in FIG. 1A.

The speech recognition unit 108 recognizes a word uttered from the user by referring to the recognition dictionary 43 stored in the recognition dictionary storage unit 107 in consideration of the weight of each word provided for the recognition dictionary.

The control unit 109 retrieves program information data stored in the program information storage unit 101 by using the word recognized by the speech recognition unit 108, and outputs information associated with the program. The control unit 109 receives externally distributed program information data. If the apparatus is configured to allow the user to select the type of keyword to be extracted by the keyword extraction unit 102 or the type of related word to be extracted by the related word extraction unit 105, the control unit 109 performs the corresponding selection processing. The control unit 109 also updates the viewing history 46 stored in the viewing history storage unit 103 when the user views a program. As described above, the apparatus may delete a viewing history when its elapsed time is equal to a predetermined period of time after the last viewing date and time. When a related word dictionary is to be provided externally, the control unit 109 receives it. In addition, if the apparatus is configured to allow the user to edit a related word dictionary, the apparatus performs editing processing for a related word dictionary.

The above description is an overview of the arrangement of the program retrieval apparatus according to this embodiment. The operation of this program retrieval apparatus will be described next.

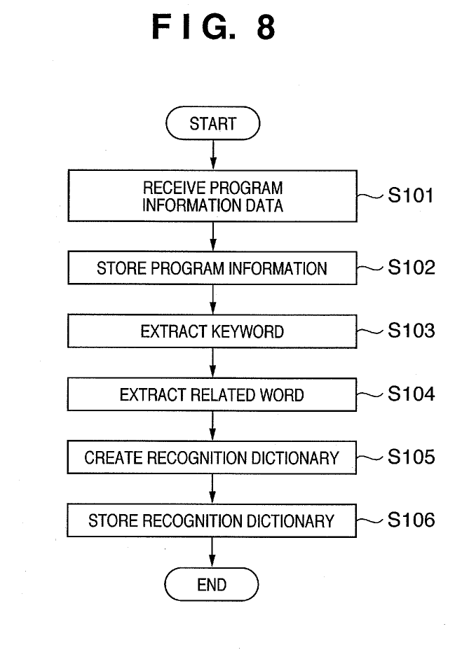

The processing of creating a recognition dictionary from program information data will be described first. FIG. 8 is a flowchart showing recognition dictionary creation processing in this program retrieval apparatus. The program retrieval program 42 contains a program corresponding to this flowchart. In practice, the CPU 1 loads this program into the RAM 3 and executes it. Note that it suffices to start this recognition dictionary creation processing at the timing designated by the user or automatically start it at a predetermined time, e.g., at 2:00 every night or 0:00 every Sunday.

First of all, the control unit 109 receives a television signal or program information data such as an EPG distributed through the Internet or the like (step S101), and stores it in the program information storage unit 101 (step S102). The keyword extraction unit 102 extracts a keyword necessary for the retrieval of a program from the program information data 45 stored in the program information storage unit 101 (step S103). As described above, this embodiment sets the types of keywords to be extracted to “station” and “title”.

The related word extraction unit 105 acquires a program exhibiting a viewing history satisfying a predetermined reference from the program information data 45, and extracts a related word of the acquired program by referring to the related word dictionary 44 (step S104).

The recognition dictionary creation unit 106 creates the recognition dictionary 43 by providing phonetic description information necessary for speech recognition for the words extracted by the keyword extraction unit 102 and the related word extraction unit 105 (step SS05), and stores the dictionary in the recognition dictionary storage unit 107 (step S106).

Program retrieval processing in this embodiment will be described next.

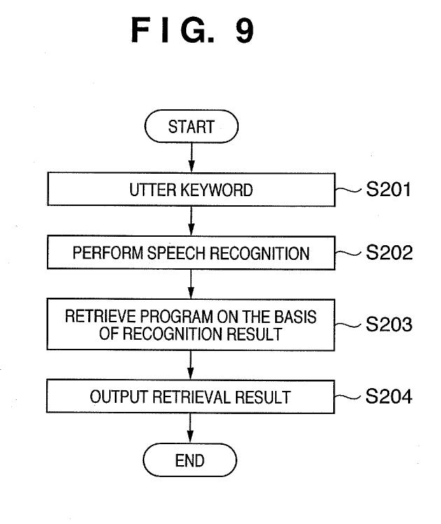

FIG. 9 is a flowchart showing program retrieval processing in this embodiment. The program retrieval program 42 contains a program corresponding to this flowchart. In practice, the CPU 1 loads this program into the RAM 3 and executes it.

The CPU 1 starts this processing when the user issues a program retrieval instruction through the operation panel 7. Upon issuing this instruction, the user utters a keyword, and the microphone 8 inputs the utterance (step S201). The speech recognition unit 108 performs speech recognition by using the recognition dictionary 43 stored in the recognition dictionary storage unit 107 (step S202). Subsequently, the control unit 109 retrieves a program corresponding to the recognition result obtained in step S202 from the program information data 45 stored in the program information storage unit 101 (step S203), and outputs the retrieval result (step S204). In step S204, to be precise, if the program information data 45 contains the corresponding program, the control unit 109 displays the information of the corresponding program on the CRT 6. If the program information data 45 does not contain the corresponding program, for example, the CPU 1 notifies the user of the corresponding information which indicates the program information data 45 does not contain the corresponding program by, for example, displaying the corresponding information on the CRT 6.

A case wherein the recognition dictionary 43 shown in FIGS. 5 and 6 has been created will be described. In this case, the user who views “Adventure TV” and “Ichirol's NEWS 7” with high frequencies performs program retrieval. With regard to these programs with high viewed frequencies, the user can perform program retrieval by using abbreviated names like “Adventure” and “NEWS 7” in addition to the titles stored in the program information data 45. In this example, the user uses abbreviated names to perform program retrieval. However, the present invention is also effective for an opposite case, i.e., a case wherein formal names are used to retrieve program information data in which each piece of program information is written with an abbreviated name or byname. When making the recognition dictionary creation unit 106 extract a related word by using the related word dictionary 44, the CPU 1 can extract a formal name on the basis of an abbreviated name or byname, and add it to the recognition dictionary 43.

According to the above arrangement, the CPU 1 registers related words of keywords associated with programs which the user viewed with high viewed frequencies in the recognition dictionary 43 on the basis of the program information data 45, viewing history 46, and related word dictionary 44. In other words, the CPU 1 does not register related words of keywords associated with programs which the user viewed with low viewed frequencies in the recognition dictionary 43. In this manner, the CPU 1 registers useful words for the user in the recognition dictionary 43 while reducing the number of unnecessary words registered. This increases the number of types of words which can be used for program retrieval with respect to programs with high viewed frequencies while suppressing an increase in the number of words registered in the recognition dictionary 43. In addition, determining weights for the words registered in the recognition dictionary 43 on the basis of viewed frequencies facilitates recognition of words associated with programs with high viewed frequencies. Using the program retrieval apparatus which can obtain the above effects makes it possible to implement a speech interface which is easy for the user to use.

### Second Embodiment

The second embodiment will exemplify a case wherein program retrieval is performed by using a viewing history storage method different from that in the first embodiment described above.

According to the method of storing a viewing history for each title as in the first embodiment, it is difficult to reflect, in a viewing history, the viewing tendency of the user who periodically views a program whose title changes every time it is broadcast, such as a movie program. Assume that a given user views a movie started from 21:00 every Friday without fail. In this case, if the title distributed with program information data changes every week in accordance with the title of the movie, the corresponding frequency in the viewing history does not increase. Therefore, a related word of this program may not be registered in the recognition dictionary for ever. In addition, the same problem may occur when a provider for program information data such as an EPG starts distributing an abbreviation of a title at a given time point. This embodiment will exemplify a method of storing a viewing history for each time slot in order to solve such a problem.

The program retrieval apparatus of this embodiment can be implemented by the same arrangement as that of the program retrieval apparatus described in the first embodiment. Only the differences between the processing performed by the respective modules in the first embodiment and that in the second embodiment will be described, and a description of the remaining part will be omitted.

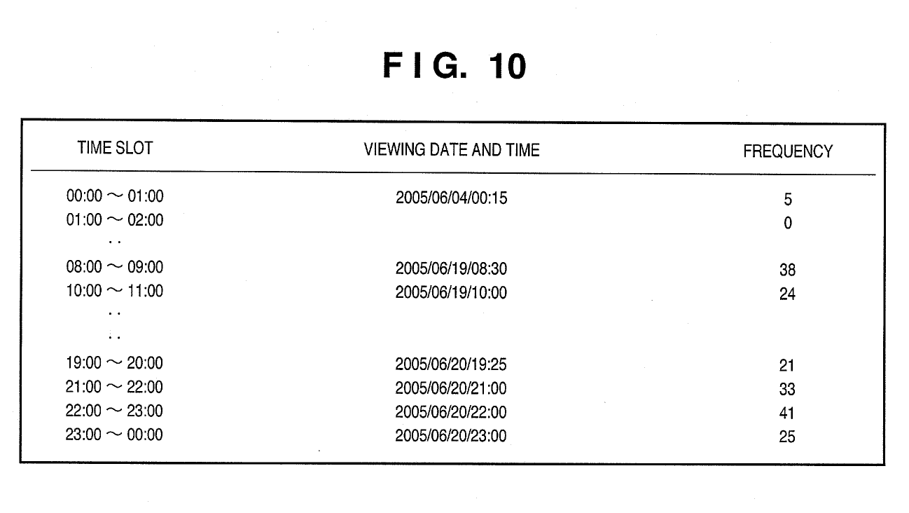

An example of storing a viewing history for each time slot will be described first. FIG. 10 shows an example of the data structure of a viewing history 46 in this embodiment. When a viewing history is to be recorded for each time slot, for example, as shown in FIG. 10, the viewing history 46 contains data of “time slot”, data of “viewing date and time” indicating the date and time at which the user lastly viewed a program in a corresponding time slot, and data of “frequency”. If, for example, the user viewed the TV from 8:15, the apparatus updates the viewing date and time of the time slot “08:00-09:00”, and increases the frequency in the time slot by one. Likewise, when the user started to view a baseball broadcast from 19:10 and viewed dramas and news until 22:40, the apparatus updates the viewing histories in the corresponding time slots, i.e., from “19:00-20:00” to “22:00-23:00”.

When recording a viewing history, it is preferable to impose a restriction that only when the user views a given program for a predetermined period of time, e.g., a three min or more, a viewing history is recorded, so as not to reflect, in a viewing history, even a case of changing the channel for channel selection.

When updating a viewing history, if “viewing date and time” before updating of the time slot coincides with “viewing date and time” at the time of updating, the apparatus updates only “viewing date and time” but does not update “frequency”.

A method of extracting a related word in a related word extraction unit 105 in a case wherein it refers to the viewing history stored for each time slot described above will be described next.

The related word extraction unit 105 extracts a related word of program information about a program in a time slot, whose viewing history satisfies a predetermined criterion, from program information data 45 stored in a program information storage unit 101 by referring to the viewing history 46 stored in a viewing history storage unit 103. Assume that this apparatus is to extract related words with reference to “frequency of 30 or more” from the program information data 45 shown in FIG. 2, a related word dictionary 44 shown in FIG. 4, and the viewing history 46 shown in FIG. 10. In this case, the corresponding time slots are “08:00-09:00”, “21:00-22:00”, and “22:00-23:00”. The programs broadcast in these time slots in the program information data 45 in FIG. 2 are “Fight!”, “Hey! Hey! Poffy AKIYUKI”, and “Lucky's great adventure”. The related word extraction unit 105 extracts related words of the pieces of program information about these programs by referring to the related word dictionary 44. When, for example, extracting only related words of “title” in the above case, the related word extraction unit 105 extracts “Hey! Poffy” and “Lucky's”.

With regard to a program broadcast across a plurality of time slots, e.g., a program broadcast from 21:00 to 22:50, it is preferable to extract a related word when the frequency in the viewing history in “21:00-22:00” or “22:00-23:00” satisfies the above criterion.

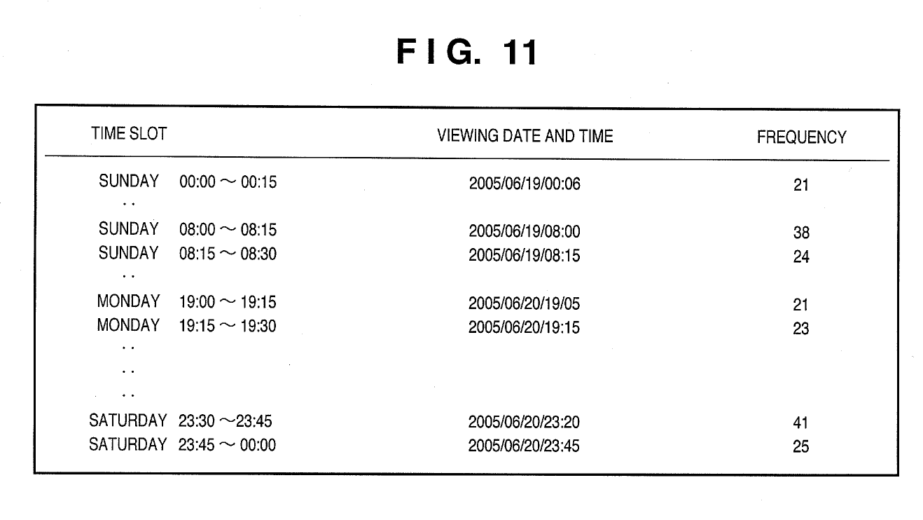

The above description has exemplified the case wherein a viewing history is stored for each time slot of a program. However, the present invention is not limited to this. For example, as shown in FIG. 11, the apparatus may store a viewing history for each time slot where the time slot can be defined in terms of any common time measure including but not limited to seconds, minutes, hours, day of the week and date. The apparatus may also use a method of combining “station”, “category” and the like as well as aforementioned time elements constituting a time slot. For example, combining a day and a category makes it possible to store a viewing history for each classification such as “Monday drama”, “news from Monday to Friday”, or “Saturday movie”.

As described above, storing a viewing history for each time slot makes it possible to properly store the viewing history of the user. As a consequence, the apparatus can perform processing based on a viewing history more properly, thus improving the convenience for the user.

### Third Embodiment

Although the above embodiment has exemplified the program retrieval apparatus which retrieves programs, the present invention is not limited to this. The present invention can be applied to, for example, a bibliographic retrieval system which retrieves books. In this case, a viewing history in the above embodiments corresponds to, for example, the sales of a book. Giving a consideration to the category of a book makes it possible to implement this technique in the same manner as for a time slot in the above embodiment. More specifically, considering the categories of books amounts to considering the sales in each category of each book instead of the sales of each book. In this case, this apparatus registers, in a speech recognition dictionary, related words of the titles of books belonging to categories exhibiting high sales. The present invention can also be applied to a music retrieval system which retrieves musical compositions. In this case, the sales of musical compositions, request counts, and the like correspond to viewing histories in the above embodiments. Giving a consideration to the categories of musical components makes it possible to implement the same techniques as those in the above embodiments.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-380168, filed Dec. 28, 2005, which is hereby incorporated by reference herein in its entirety.

What is claimed is:

1. An information retrieval apparatus which retrieves a program by using speech recognition, comprising:
a recognition dictionary storage unit configured to store a recognition dictionary in which a lexicon for the speech recognition is described;
a program information storage unit configured to store program information data;
a viewing history storage unit configured to store a viewing history including information of a viewed frequency of a program which a user viewed in the past;
an extraction unit configured to extract a program which satisfies a criterion concerning the viewed frequency from the program information data;
a registration unit configured to register a related word of a program extracted by said extraction unit in the recognition dictionary;
a speech recognition unit configured to perform speech recognition with respect to an input speech by using the recognition dictionary in which the related word is registered by said registration unit; and
a retrieval unit configured to retrieve a program corresponding to the result of the speech recognition from the program information data.

2. The apparatus according to claim 1, wherein the viewing history includes information of a viewed frequency for each program which the user viewed in the past.

3. The apparatus according to claim 1, wherein the viewing history includes information of a viewed frequency for each time slot.

4. The apparatus according to claim 3, wherein the time slot includes at least one of a time in which a program is broadcast, a day on which a program is broadcast, a station which broadcasts a program, and a category of a program.

5. The apparatus according to claim 1, wherein
the recognition dictionary includes a weighting coefficient corresponding to a viewed frequency for each lexicon item, and
said speech recognition unit includes a unit configured to weight a recognition score of each lexicon item with the corresponding weighting coefficient.

6. The apparatus according to claim 1, wherein the related word includes at least one of an abbreviated name, byname, synonym, thesaurus item, and translated word.

7. The apparatus according to claim 1, wherein the program information data comprises electronic program guide data.

8. An information retrieval method executed by an information retrieval apparatus having a recognition dictionary storage unit configured to store a recognition dictionary in which a lexicon for the speech recognition is described, a program information storage unit configured to store program information data, and a viewing history storage unit configured to store a viewing history including information of a viewed frequency of a program which a user viewed in the past, the method comprising the steps of:
extracting a program which satisfies a criterion concerning the viewed frequency from the program information data;
registering a related word of the extracted program in the recognition dictionary;
performing speech recognition with respect to an input speech by using the recognition dictionary in which the related word is registered; and
retrieving a program corresponding to the result of the speech recognition from the program information data.

9. A computer program for retrieving information using an information retrieval system having a computer executing the computer program, a recognition dictionary storage unit configured to store a recognition dictionary in which a lexicon for the speech recognition is described, a program information storage unit configured to store program information data, and a viewing history storage unit configured to store a viewing history containing information of a viewed frequency of a program which a user viewed in the past, the computer program comprising code for performing the following steps:
extracting a program which satisfies a criterion concerning the viewed frequency from the program information data;
registering a related word of the extracted program in the recognition dictionary;
performing speech recognition with respect to an input speech by using the recognition dictionary in which the related word is registered; and
retrieving a program corresponding to the result of the speech recognition from the program information data.
